(19) United States
(12) Patent Application Publication
(10) Pub. No.: US 2024/0103199 A1
(43) Pub. Date: Mar. 28, 2024

(54) WINDOW AND DISPLAY DEVICE INCLUDING THE SAME

(71) Applicant: SAMSUNG DISPLAY CO., LTD., YONGIN-SI (KR)

(72) Inventors: HUNG KUN AHN, Yongin-si (KR); Seunghwan CHUNG, YONGIN-SI (KR); Sang-il PARK, YONGIN-SI (KR); Minseong BYEON, YONGIN-SI (KR)

(21) Appl. No.: 18/462,467

(22) Filed: Sep. 7, 2023

(30) Foreign Application Priority Data
Sep. 7, 2022 (KR) 10-2022-0113462

(51) Int. Cl. G02B 1/04; C09D 7/61; C09D 133/10; C09D 183/08

(52) U.S. Cl. CPC G02B 1/04; C09D 7/61; C09D 133/10; C09D 183/08

(57) ABSTRACT

A window includes a base layer, a high refractive layer disposed on the base layer, and a low refractive layer disposed on the high refractive layer. The high refractive layer includes inorganic particles and a base resin, and the low refractive layer includes a fluorine-containing silsesquioxane-based resin.

### CROSS-REFERENCE TO RELATED APPLICATIONS

This U.S. non-provisional patent application claims priority under 35 U.S.C. § 119 from Korean Patent Application No. 10-2022-0113462, filed on Sep. 7, 2022 in the Korean Intellectual Property Office, the contents of which are herein incorporated by reference in their entirety.

### TECHNICAL FIELD

Embodiments of the present disclosure herein are directed to a window and a display device that includes the window.

### DISCUSSION OF THE RELATED ART

Various types of electronic devices are being used to provide image information, and electronic devices have been developed that include flexible display devices that are foldable or bendable. Flexible display devices, unlike rigid display devices, can have their shape modified by being folded, rolled, or bent, and are thus portable without being limited to display screen sizes.

Such a flexible display device needs a window that protects a display panel without affecting the folding or bending operation.

### SUMMARY

Embodiment of the present disclosure provide a window that has both increased optical properties and mechanical durability.

Embodiments of the present disclosure also provide a display device that includes a window with increased optical properties and mechanical durability, thereby increasing display quality and durability.

An embodiment of the inventive concept provides a window that includes a base layer, a high refractive layer disposed on the base layer and that includes inorganic particles and a base resin, and a low refractive layer disposed on the high refractive layer and that includes a fluorine-containing silsesquioxane-based resin.

In an embodiment, the fluorine-containing silsesquioxane-based resin is a silsesquioxane-based resin that includes at least one perfluoroalkyl group.

In an embodiment, the fluorine-containing silsesquioxane-based resin includes at least one of a (meth)acrylate group or an epoxy group.

In an embodiment, the fluorine-containing silsesquioxane-based resin includes a repeating unit represented by Formula 1 below.

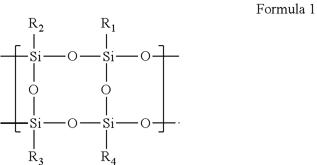

In Formula 1, R₁ to R₄ are each independently one of a hydrogen atom, a deuterium atom, a halogen atom, a substituted or unsubstituted alkyl group, a substituted or unsubstituted (meth)acrylate group, a substituted or unsubstituted aryl group having 6 to 30 carbon atoms, an alkoxy group that has 1 to 10 carbon atoms substituted with an epoxy group, or a substituted or unsubstituted heteroaryl group having 2 to 30 carbon atoms. At least one of R₁ to R₄ is a substituted or unsubstituted fluoroalkyl group that has 1 to 20 carbon atoms, or a substituted or unsubstituted perfluoroalkyl group that has 1 to 20 carbon atoms, and at least another one of R₁ to R₄ is a substituted or unsubstituted (meth)acrylate group, or an alkoxy group that has 1 to 10 carbon atoms substituted with an epoxy group.

In an embodiment, the fluorine-containing silsesquioxane-based resin includes a repeating unit represented by Formula 2 below.

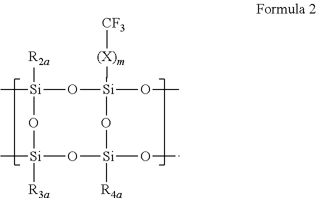

In Formula 2, X is —CF₂—, m is an integer that is greater than or equal to 1 and less than or equal to 11, R₂ₐ to R₄ₐ are each independently one of a substituted or unsubstituted fluoroalkyl group that has 1 to 20 carbon atoms, a substituted or unsubstituted perfluoroalkyl group that has 1 to 20 carbon atoms, a substituted or unsubstituted (meth)acrylate group, or an alkoxy group that has 1 to 10 carbon atoms substituted with an epoxy group, and at least one of R₂ₐ to R₄ₐ is a substituted or unsubstituted (meth)acrylate group, or an alkoxy group that has 1 to 10 carbon atoms substituted with an epoxy group.

In an embodiment, R₂ₐ to R₄ₐ are each independently represented by one of Formula 3-1 or Formula 3-2 below.

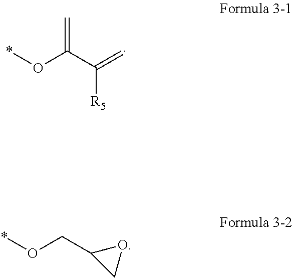

In Formulas 3-1 and 3-2, R₅ is a hydrogen atom or a substituted or unsubstituted methyl group, and [symbol] is a site connected to Si of Formula 2.

In an embodiment, the high refractive layer has a refractive index of greater than about 1.55 and less than about 1.65, and the low refractive layer has a refractive index of greater than about 1.40 and less than about 1.45.

In an embodiment, the inorganic particles include at least one of niobium oxide or zirconium oxide.

In an embodiment, the high refractive layer includes the inorganic particles in an amount of greater than about 5 wt % and less than about 25 wt % with respect to a total amount of the high refractive layer.

In an embodiment, the base resin includes a (meth)acrylate-based resin.

In an embodiment, the base resin includes a polymer derived from a resin composition that includes at least one of 3-functional (meth)acrylate, 6-functional (meth)acrylate, or 9-functional (meth)acrylate.

In an embodiment, the low refractive layer includes no inorganic particles.

In an embodiment, the window further includes a functional layer disposed on the low refractive layer and that includes a fluorine-containing compound.

In an embodiment of the inventive concept, a display device includes a display panel and a window disposed on the display panel. The window includes a base layer disposed on the display panel, a high refractive layer disposed on the base layer and that includes inorganic particles and a base resin, and a low refractive layer disposed on the high refractive layer and that includes a fluorine-containing silsesquioxane-based resin.

In an embodiment, the fluorine-containing silsesquioxane-based resin is a silsesquioxane-based resin that includes at least one perfluoroalkyl group.

In an embodiment, the fluorine-containing silsesquioxane-based resin includes at least one of a (meth)acrylate group or an epoxy group.

In an embodiment, the fluorine-containing silsesquioxane-based resin includes a repeating unit represented by Formula 1 below.

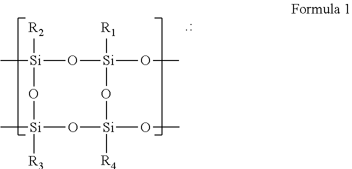

In Formula 1, R₁ to R₄ are each independently one of a hydrogen atom, a deuterium atom, a halogen atom, a substituted or unsubstituted alkyl group, a substituted or unsubstituted (meth)acrylate group, a substituted or unsubstituted aryl group that has 6 to 30 carbon atoms, an alkoxy group that has 1 to 10 carbon atoms substituted with an epoxy group, or a substituted or unsubstituted heteroaryl group having 2 to 30 carbon atoms. At least one of R₁ to R₄ is a substituted or unsubstituted fluoroalkyl group that has 1 to 20 carbon atoms, or a substituted or unsubstituted perfluoroalkyl group that has 1 to 20 carbon atoms, and at least another one of R₁ to R₄ is a substituted or unsubstituted (meth)acrylate group, or an alkoxy group that has 1 to 10 carbon atoms substituted with an epoxy group.

In an embodiment, the fluorine-containing silsesquioxane-based resin includes a repeating unit represented by Formula 2 below.

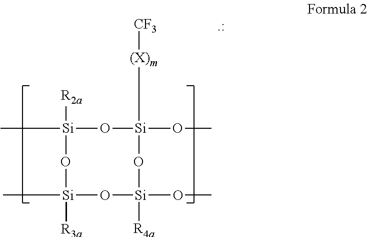

In Formula 2, X is —CF₂—, m is an integer that is greater than or equal 1 and less than or equal to 11, R₂ₐ to R₄ₐ are each independently one of a substituted or unsubstituted fluoroalkyl group that has 1 to 20 carbon atoms, a substituted or unsubstituted perfluoroalkyl group that has 1 to 20 carbon atoms, a substituted or unsubstituted (meth)acrylate group, or an alkoxy group that has 1 to 10 carbon atoms substituted with an epoxy group, and at least one of R₂ₐ to R₄ₐ is a substituted or unsubstituted (meth)acrylate group, or an alkoxy group that has 1 to 10 carbon atoms substituted with an epoxy group.

In an embodiment, the high refractive layer has a refractive index of that is greater than about 1.55 and less than about 1.65, and the low refractive layer has a refractive index that is greater than about 1.40 and less than about 1.45.

In an embodiment, the display device includes at least one foldable region that can be folded with respect to a folding axis that extends in one direction.

### BRIEF DESCRIPTION OF THE FIGURES

FIG. 1A is a perspective view of an unfolded display device according to an embodiment of the inventive concept.

FIG. 1B is a perspective view of an in-folding process of a display device according to an embodiment of the inventive concept.

FIG. 1C is a perspective view of an out-folding process of a display device according to an embodiment of the inventive concept.

FIG. 2A is a perspective view an unfolded display device according to an embodiment of the inventive concept.

FIG. 2B is a perspective view of an in-folding process of a display device according to an embodiment of the inventive concept shown in FIG. 2A.

FIG. 3 is an exploded perspective view of a display device according to an embodiment of the inventive concept.

FIG. 4 is a cross-sectional view of a display device according to an embodiment of the inventive concept.

FIG. 5 is a cross-sectional view of a window according to an embodiment of the inventive concept.

FIG. 6 is a cross-sectional view of a window according to an embodiment of the inventive concept.

### DETAILED DESCRIPTION

Hereinafter, embodiments of the inventive concept will be described with reference to the drawings.

As used herein, when an element (or a region, a layer, a portion, etc.) is referred to as being “on,” “connected to,” or “coupled to” another element, it means that the element may be directly connected to/coupled to the other element, or that a third element may be disposed therebetween.

Like numbers may refer to like elements throughout.

The term “about” as used herein is inclusive of the stated value and means within an acceptable range of deviation for the particular value as determined by one of ordinary skill in the art, considering the measurement in question and the error associated with measurement of the particular quantity, such as the limitations of the measurement system. For example, “about” may mean within one or more standard deviations as understood by one of the ordinary skill in the art. Further, it is to be understood that while parameters may be described herein as having “about” a certain value, according to embodiments, the parameter may be exactly the certain value or approximately the certain value within a measurement error as would be understood by a person having ordinary skill in the art.

Hereinafter, a window according to an embodiment of the inventive concept and a display device according to an embodiment that includes the same will be described with reference to the accompanying drawings.

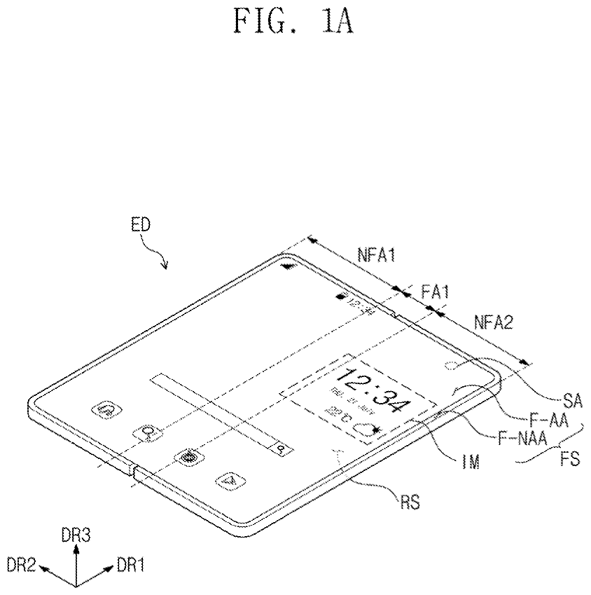

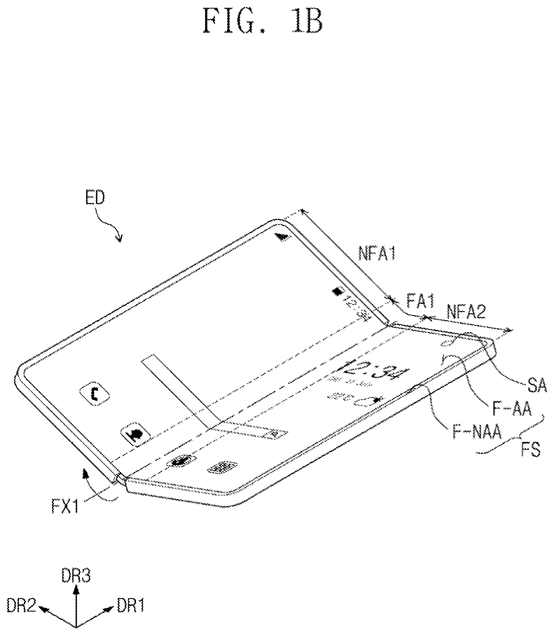

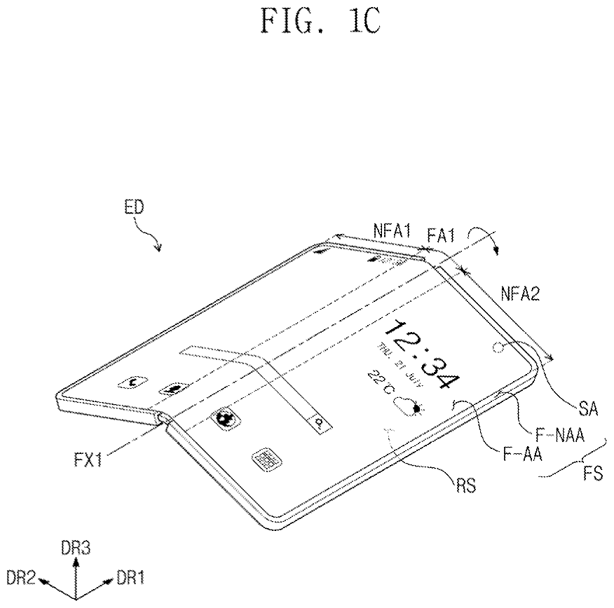

FIG. 1A is a perspective view of an unfolded display device according to an embodiment. FIG. 1B is a perspective view of an in-folding process of a display device shown in FIG. 1A. FIG. 1C is a perspective view of an out-folding process of a display device shown in FIG. 1A.

A display device ED can be activated by an electrical signal. For example, the display device ED is one of a mobile phone, a tablet, a car navigation system, a game console, or a wearable device, but embodiments of the inventive concept are not necessarily limited thereto. In FIGS. 1A to 1C, et seq., as an example, a mobile phone is shown as the display device ED.

In FIGS. 1A to 1C, the display device ED is shown as a foldable display device that can be deformed into a folded shape, but embodiments of the inventive concept are not necessarily limited thereto, and in some embodiments, the display device ED is a flexible display device that can be bent or rolled.

FIG. 1A and the following drawings show first, second and third directions DR1, DR2 and DR3 that cross each other, and directions indicated by the first to third directions DR1, DR2, and DR3 described herein are relative concepts, and may thus be changed to other directions. In addition, the directions indicated by the first to third direction axes DR1, DR2, and DR3 are described as first to third directions, for which the same reference numerals may be used.

Referring to FIGS. 1A to 1C, the display device ED according to an embodiment includes a display surface FS that is parallel to a plane defined by the first direction DR1 and the second direction DR2. The display device ED displays an image IM to users through the display surface FS. The display device ED according to an embodiment displays the image IM in the third direction DR3 normal to the display surface FS. In the present description, a front surface (or an upper surface) and a rear surface (or a lower surface) of respective members are defined with respect to a direction in which the image IM is displayed.

The display device ED according to an embodiment can detect external applied inputs. The external inputs can include various forms. For example, the external inputs include approaching to or hovering over at a predetermined distance, as well as contacts by body parts such as a user's hand. In addition, the external inputs have various forms, such as force, pressure, temperature, light, etc.

The display device ED includes an active region F-AA and a peripheral region F-NAA. The active region F-AA is activated by electrical signals. The display device ED according to an embodiment displays the image IM through the active region F-AA. In addition, the active region F-AA can detect various forms of external inputs. The peripheral region F-NAA is adjacent to the active region F-AA. The peripheral region F-NAA has a predetermined color. The peripheral region F-NAA surrounds the active region F-AA. Accordingly, the shape of the active region F-AA is substantially defined by the peripheral region F-NAA. However, embodiments are not necessarily limited thereto, and in other embodiments, the peripheral region F-NAA is disposed adjacent to only one side of the active region F-AA, or is omitted. The display device ED according to an embodiment of the inventive concept includes various forms of active regions and is not necessarily limited to any one embodiment.

The active region F-AA includes a sensing region SA. The sensing region SA may have various electronic modules disposed therein. For example, the electronic modules include at least one of a camera module, a speaker, a light detection sensor, or a heat detection sensor. The sensing region SA detects an external subject through the display surface FS, or transmits sound signals such as voice through the display surface FS. The electronic modules include a plurality of components, and are not necessarily limited to any one embodiment.

In an embodiment, the sensing region SA is surrounded by the active region F-AA and the peripheral region F-NAA. However, embodiments of the inventive concept are not necessarily limited thereto, and in other embodiments, the sensing region SA is disposed in the active region F-AA. In FIG. 1A, et seq., one sensing region SA is shown as an example, but the number of sensing regions SA is not necessarily limited thereto.

The sensing region SA is a portion of the active region F-AA. Accordingly, the display device ED can display images through the sensing region SA. When electronic modules disposed in the sensing region SA are deactivated, the sensing region SA, as a display surface, can display videos or images.

A rear surface RS of the display device ED according to an embodiment faces the display surface FS. In an embodiment, the rear surface RS is an outer surface of the display device ED, and does not display videos or images. However, embodiments of the inventive concept are not necessarily limited thereto, and in some embodiments, the rear surface RS is a second display surface on which videos or images are displayed. In addition, the display device ED according to an embodiment further includes a sensing region disposed on the rear surface RS. For example, a camera, a speaker, a light detection sensor, etc., may also be disposed in the sensing region on the rear surface RS.

The display device ED includes a foldable region FA1 and non-foldable regions NFA1 and NFA2. The display device ED includes a plurality of non-foldable regions NFA1 and NFA2. The display device ED according to an embodiment includes a first non-foldable region NFA1 and a second non-foldable region NFA2 spaced apart in the second direction DR2 with the foldable region FA1 interposed therebetween. Although FIGS. 1A to 1C show an embodiment of the display device ED that includes one foldable region FA1, embodiments of the inventive concept are not necessarily limited thereto, and in some embodiment, the display device ED includes a plurality of foldable regions that can be folded with respect to a plurality of folding axes such that portions of the display surface FS can face each other. However, the number of folding axes and the number of the corresponding non-foldable regions are not particularly limited.

Referring to FIGS. 1B and 1C, the display device ED according to an embodiment can be folded with respect to a first folding axis FX1. The first folding axis FX1 shown in FIGS. 1B and 1C is a virtual axis that extends in the first direction DR1, and the first folding axis FX1 is parallel to a long side of the display device ED. However, embodiments of the inventive concept are not necessarily limited thereto, and the extension direction of the first folding axis FX1 is not necessarily limited to the first direction DR1.

The first folding axis FX1 may extend on the display surface FS along the first direction DR1 or may extend below the rear surface RS along the first direction DR1. Referring to FIG. 1B, in an embodiment, the first non-foldable region NFA1 and the second non-foldable region NFA2 face each other, and the display device ED is in-folded such that the display surface FS is not externally exposed. In addition, referring to FIG. 1C, the display device ED is out-folded with respect to the first folding axis FX1 such that one region of the rear surface RS that overlaps the first non-foldable region NFA1 and the other region of the rear surface RS that overlaps the second non-foldable region NFA2 face each other.

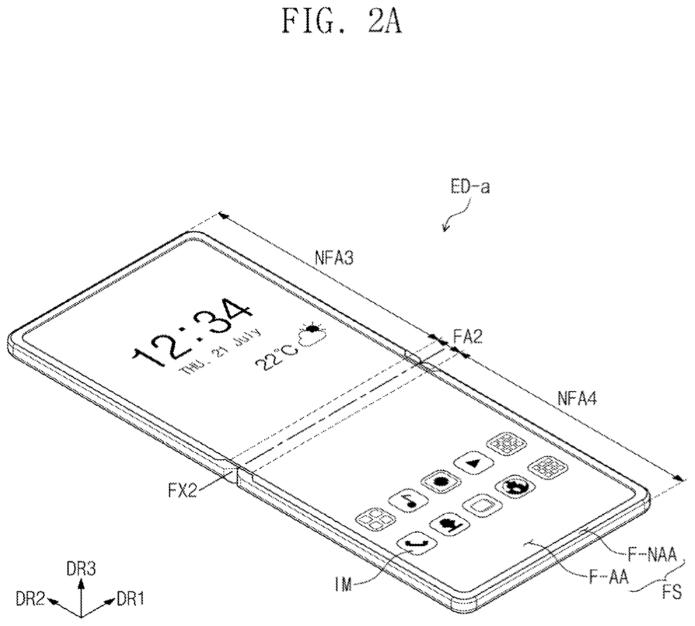

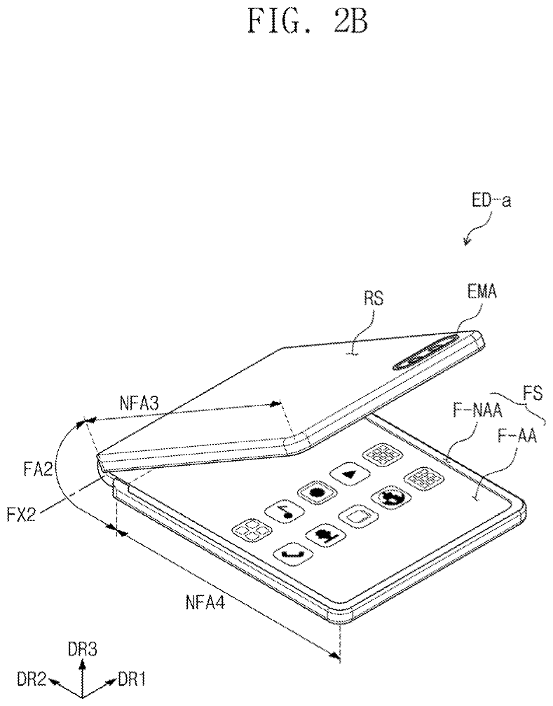

FIG. 2A is a perspective view of an unfolded display device according to an embodiment. FIG. 2B is a perspective view of an in-folding process of a display device shown in FIG. 2A.

A display device ED-a according to an embodiment can be folded with respect to a second folding axis FX2 that extends in the first direction axis DR1. FIGS. 2A and 2B show a case in which an extension direction of the second folding axis FX2 is parallel to a short side of the display device ED-a. However, embodiments of the inventive concept are not necessarily limited thereto.

The display device ED-a according to an embodiment includes at least one foldable region FA2 and non-foldable regions NFA3 and NFA4 adjacent to the foldable region FA2. The non-foldable regions NFA3 and NFA4 are spaced apart from each other in the second direction DR2 with the foldable region FA2 interposed therebetween.

The foldable region FA2 has a predetermined curvature and a predetermined radius of curvature. In an embodiment, the display device ED-a is in-folded such that the third non-foldable region NFA3 and the fourth non-foldable region NFA4 face each other, and the display surface FS is not externally exposed.

In addition, in an embodiment, the display device ED-a is out-folded such that the display surface FS is externally exposed. However, in an embodiment, when the display device ED-a is unfolded, the first display surface FS can be viewed by users and when in-folded, a second display surface RS can be viewed by users.

The display device ED-a according to an embodiment includes the second display surface RS, and the second display surface RS faces at least a portion of the first display surface FS. When the display device ED-a is in-folded, the second display surface RS can be viewed by users. The second display surface RS includes an electronic module region EMA in which electronic modules that include various components are disposed. In addition, in an embodiment, images can be displayed through the second display surface RS.

In an embodiment, the display devices ED and ED-a are configured such that an in-folding operation or an out-folding operation and an unfolding operation can be mutually repeated, but embodiments of the inventive concept are not necessarily limited thereto. In an embodiment, the display devices ED and ED-a are configured to select one of an unfolding operation, an inner-folding operation, or an outer-folding operation.

FIGS. 1A to 2B show the display devices ED and ED-a as foldable display devices deformable into a folded shape, but embodiments of the inventive concept are not necessarily limited thereto, and the display devices ED and ED-a according to other embodiments are flexible display devices that are bendable or rollable.

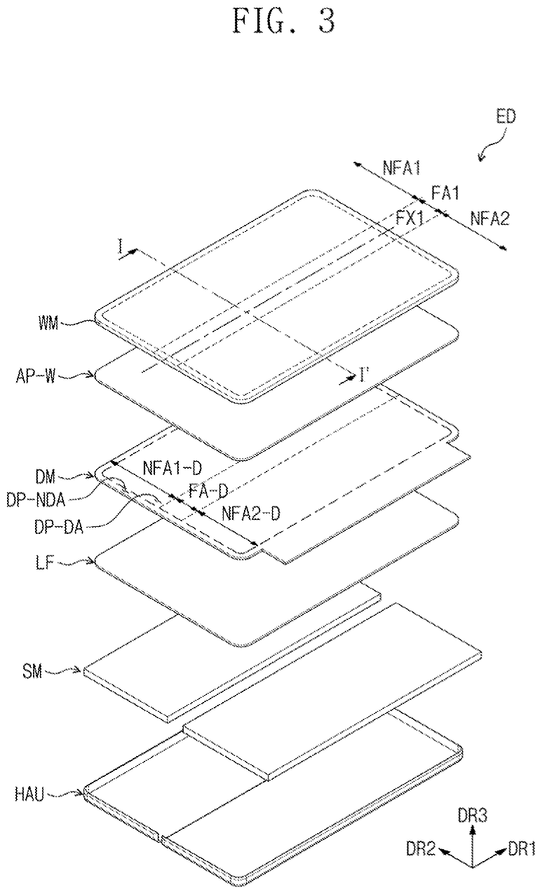

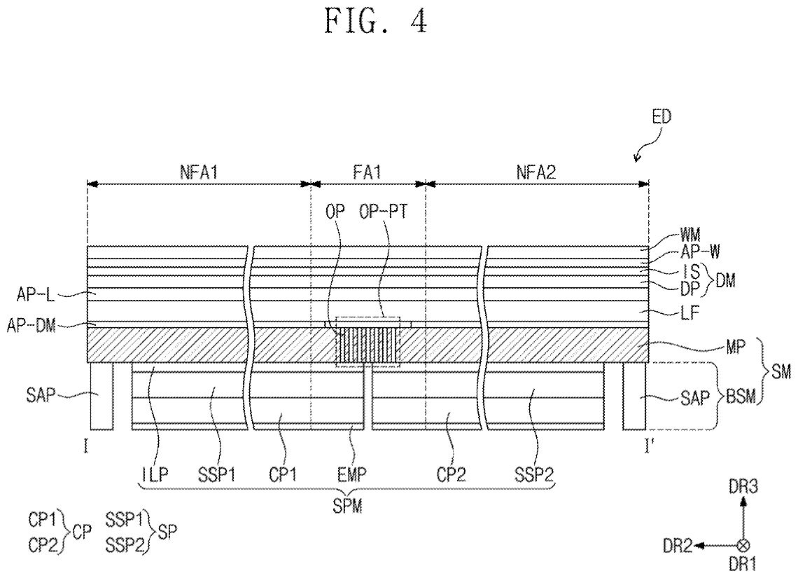

FIG. 3 is an exploded perspective view of a display device according to an embodiment, and FIG. 4 is a cross-sectional view of a display device according to an embodiment. FIG. 3 is an exploded perspective view of a display device according to an embodiment shown in FIG. 1A as an example. FIG. 4 is a cross-sectional view of a portion that corresponds to line I-I′ of FIG. 3.

Referring to FIGS. 3 and 4, the display device ED of an embodiment includes a display module DM and a window WM disposed above the display module DM. In addition, the display device ED according to an embodiment includes a support module SM disposed below the display module DM, and a housing HAU. In FIGS. 3 and 4, the display device ED shown in FIGS. 1A to 1C is described as an embodiment, but the following descriptions may equally apply to the display device ED-a shown in FIGS. 2A and 2B.

The window WM covers an entire outer portion of the display module DM. The window WM has a shape that corresponds to the shape of the display module DM. In addition, the display device ED of an embodiment includes a housing HAU that accommodates the display module DM, the support module SM, etc. The housing HAU is bonded to the window WM. In addition, the housing HAU further includes a hinge structure to facilitate folding or bending.

In the display device ED of an embodiment, the display module DM displays images according to electrical signals and transmits/receives information based on external inputs. A display surface of the display module DM is divided into a display region DP-DA and a non-display region DP-NDA. The display region DP-DA displays images provided from the display module DM.

The non-display region DP-NDA is adjacent to the display region DP-DA. In an embodiment, the non-display region DP-NDA surrounds the display region DP-DA. However, embodiments are not necessarily limited thereto, and in other embodiments, the non-display region DP-NDA has various other shapes. According to an embodiment, the display region DP-DA of the display module DM corresponds to at least a portion of the first active region F-AA (FIG. 1A).

In the display device ED according to an embodiment, the display module DM includes a foldable display portion FA-D and non-foldable display portions NFA1-D and NFA2-D. The foldable display portion FA-D corresponds to the foldable region FA1 of the display device ED, and the non-foldable display portions NFA1-D and NFA2-D corresponding to the non-foldable regions NFA1 and NFA2 of the display device ED.

The window WM according to an embodiment is disposed on the display module DM. The window WM includes an optically transparent insulating material. The window WM protects the display panel DP and a sensor layer IS. For example, the window WM covers an upper portion of the display module DM.

The image IM (FIG. 1A) generated by the display panel DP is provided to users by being displayed through the window WM. The window WM provides a touch surface for the display device ED. In the display device ED that includes the foldable region FA1, the window WM is flexible and can be folded.

The window WM is a display surface and a touch surface, and exhibits excellent optical properties. The window WM according to an embodiment has a transmittance of 90% or greater in a visible light range of about 380 nm to about 780 nm.

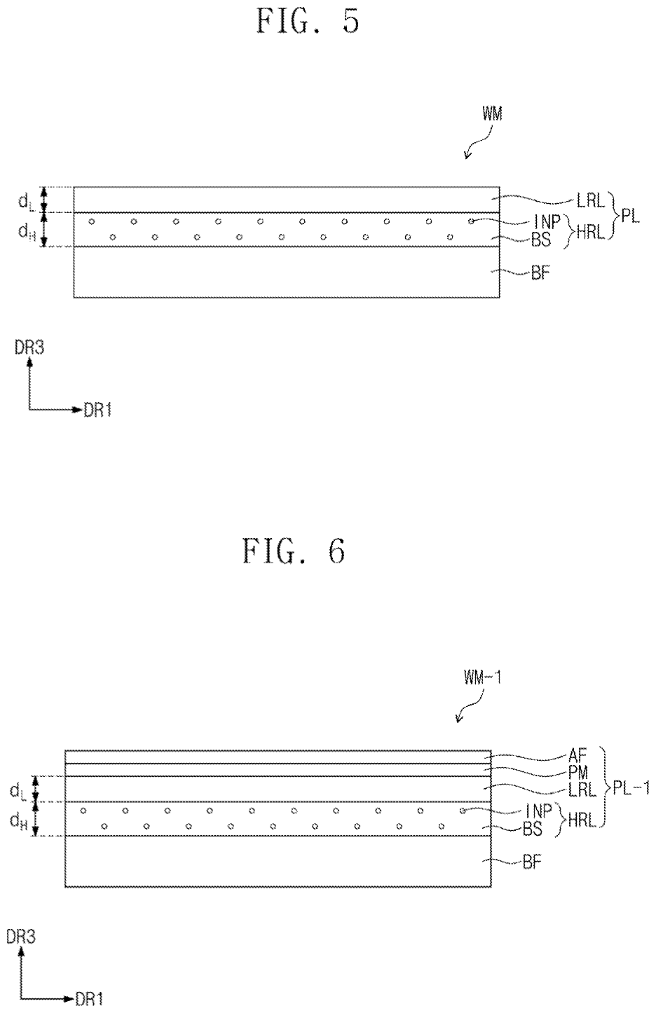

The window WM according to an embodiment includes a base layer BF (FIG. 5) and an anti-reflection film PL (FIG. 5) disposed on the base layer BF (FIG. 5). The anti-reflection film PL (FIG. 5) includes a high refractive layer HRL (FIG. 5) and a low refractive layer LRL (FIG. 5) disposed on the high refractive layer HRL (FIG. 5). The window WM according to an embodiment will be described in more detail below.

The display module DM includes a display panel DP and a sensor layer IS disposed on the display panel DP. In addition, the display module DM further includes an optical layer disposed on the sensor layer IS. The optical layer reduces reflection by external light. For example, the optical layer includes a polarizing layer or a color filter layer.

The display panel DP generates images. For example, the display panel DP is one of an organic light emitting display panel, an inorganic light emitting display panel, a quantum dot display panel, a micro LED display panel, a nano LED display panel, or a liquid crystal display panel. The display panel DP may be referred to as a display layer.

The sensor layer IS is disposed on the display panel DP. The sensor layer IS detect externally applied inputs. The external inputs may be user inputs. The user inputs may include various types of external inputs such as a user's body part, light, heat, pen, or pressure.

In the display module DM according to an embodiment, the sensor layer IS is formed on the display panel DP through a continuous process. For example, the sensor layer IS is directly disposed on the display panel DP. Being directly disposed indicates that a third component is not disposed between the sensor layer IS and the display panel DP. For example, a separate adhesive member is not disposed between the sensor layer IS and the display panel DP. However, embodiments are not necessarily limited thereto, and in an embodiment of the inventive concept, the sensor layer IS is bonded to the display panel DP through an adhesive member. The adhesive member may include a general adhesive or a gluing agent.

A window adhesive layer AP-W is disposed between the window WM and the display module DM. The window adhesive layer AP-W may be an optically clear adhesive film (OCA) or an optically clear adhesive resin layer (OCR).

The display device ED of an embodiment further includes a lower film LF disposed below the display module DM. The lower film LF protects a lower portion of the display panel DP. The display device ED according to an embodiment includes a lower adhesive layer AP-L (FIG. 4) that bonds the display module DM with the lower film LF.

The lower film LF is a polymer film. For example, the lower film LF includes at least one of a polyethylene terephthalate (PET) film or a polyimide (PI) film. The lower film LF prevents scratches from occurring on a rear surface of the display panel DP in a manufacturing process of the display panel DP. In addition, the lower film LF protects the display panel DP from external pressure, and thus prevents the display panel DP from being deformed. The lower film LF may have a structure in which one film layer or a plurality of film layers are stacked.

The lower adhesive layer AP-L is disposed between the display panel DP and the lower film LF. The lower adhesive layer AP-L may be an optically clear adhesive film (OCA) or an optically clear adhesive resin layer (OCR). However, embodiments of the inventive concept are not necessarily limited thereto, and in some embodiments, the lower adhesive layer AP-L includes one of an acryl-based adhesive or a silicone-based adhesive. In addition, in an embodiment, the lower adhesive layer AP-L is omitted.

The display device ED according to an embodiment includes a support module SM disposed below the display module DM. The support module SM includes a support plate MP and a lower support member BSM.

The support plate MP is disposed below the display module DM. The support plate MP is disposed below the lower film LF. In an embodiment, the support plate MP includes one of a metal or a polymer. For example, the support plate MP includes at least one of stainless steel, aluminum, or an alloy thereof. In addition, in an embodiment, the support plate MP includes carbon fiber reinforced plastic (CFRP), etc. However, embodiments of the inventive concept are not necessarily limited thereto, and in some embodiments, the support plate MP includes at least one of a non-metallic material, plastic, a glass fiber reinforced plastic, or glass.

A plurality of openings OP are formed in the support plate MP. The support plate MP includes an opening pattern OP-PT that includes the plurality of openings OP. The opening pattern OP-PT corresponds to the foldable region FA1.

The lower support member BSM includes a support member SPM and a filling portion SAP. The support member SPM overlaps most regions of the display module DM. For example, the area of the display module DM that overlaps the support member SPM is 80% or more of the total area of the display module DM. The filling portion SAP is disposed outside the support member SPM and overlaps the outside of the display module DM.

In an embodiment, the lower support member BSM includes at least one of a support layer SP, a cushion layer CP, a shielding layer EMP, or an interlayer bonding layer ILP. However, the configuration of the lower support member BSM is not necessarily limited to that shown in FIG. 4, and in other embodiments, the configuration of the lower support member BSM varies depending on the size, shape, or operational characteristics of the display device ED. For example, in some embodiments, some of the support layer SP, the cushion layer CP, the shielding layer EMP, or the interlayer bonding layer ILP are omitted, or the stacking order thereof differs from that shown in FIG. 4, or additional components other than those described are further included. For example, in an embodiment, the lower support member BSM further includes a digitizer, etc.

The support layer SP includes at least one of a metal or a polymer. The support layer SP is disposed below the support plate MP. For example, the support layer SP is a thin film metal substrate.

The support layer SP includes a first sub support layer SSP1 and a second sub support layer SSP2 that are spaced apart from each other in the second direction DR2. The first sub support layer SSP1 and the second sub support layer SSP2 are spaced apart from each other in the second direction DR2 with respect to a portion that corresponds to the folding axis FX1. The support layers SSP1 and SSP2 are spaced apart from each other in the foldable region FA1, thereby increasing folding or bending characteristics of the display device ED.

The cushion layer CP is disposed below the support layer SP. The cushion layer CP prevents the support plate MP from being pressed and plastically deformed due to external impacts and force. The cushion layer CP increases impact resistance of the display device ED. The cushion layer CP includes at least one of a sponge, foam, or an elastomer such as a urethane resin. In addition, the cushion layer CP includes at least one of an acrylic polymer, a urethane-based polymer, a silicone-based polymer, or an imide-based polymer. However, embodiments of the inventive concept are not necessarily limited thereto.

In addition, the cushion layer CP includes a first sub cushion layer CP1 and a second sub cushion layer CP2 that are spaced apart from each other in the second direction DR2. The first sub cushion layer CP1 and the second sub cushion layer CP2 are spaced apart from each other at a portion that corresponds to the first folding axis FX1. The cushion layers CP1 and CP2 are spaced apart from each other in the foldable region FA1, thereby increasing folding or bending characteristics of the display device ED.

The shielding layer EMP is at least one of an electromagnetic wave shielding layer or a heat dissipation layer. In addition, the shielding layer EMP is a bonding layer. The interlayer bonding layer ILP bonds the support plate MP with the lower support member BSM. The interlayer bonding layer ILP includes at least one of a bonding resin layer or an adhesive tape. FIG. 4 shows the interlayer bonding layer ILP as being divided into two portions spaced apart from each other in the second direction at a portion that corresponding to the foldable region FA1, but embodiments of the inventive concept are not necessarily limited thereto, and in an embodiment, the interlayer bonding layer ILP is a single layer that is not spaced apart in the foldable region FA1.

The filling portion SAP is disposed outside the support layer SP and the cushion layer CP. The filling portion SAP is disposed between the support plate MP and the housing HAU. The filling portion SAP fills a space between the support plate MP and the housing HAU, and fixes the support plate MP.

In addition, the display device ED according to an embodiment further includes a module adhesive layer AP-DM disposed between the lower film LF and the support module SM. The module adhesive layer AP-DM is at least one of an optically clear adhesive film (OCA) or an optically clear adhesive resin layer (OCR). However, in an embodiment, an additional adhesive layer is further disposed between respective members of the support module SM.

The display device ED according to an embodiment described with reference to FIGS. 1A to 4 includes a display module DM, a window WM disposed on the display module DM, and at least one foldable region.

FIG. 5 is a cross-sectional view of a window according to an embodiment of the inventive concept. The window WM shown in FIG. 5 is the window WM of an embodiment shown in FIGS. 3 and 4. The window WM of an embodiment shown in FIG. 5 is a cover window of the display devices ED and ED-a of an embodiment described with reference to FIGS. 1A to 4.

Referring to FIG. 5, the window WM of an embodiment includes the base layer BF and the anti-reflection film PL disposed on the base layer BF. The anti-reflection film PL includes the high refractive layer HRL and the low refractive layer LRL disposed on the high refractive layer HRL. Hereinafter, descriptions of the base layer BF and the anti-reflection film PL in the window WM may equally apply to the configuration of a window WM-1 of an embodiment described with reference to FIG. 6 as well as the window WM of an embodiment shown in FIG. 5.

The base layer BF according to an embodiment includes a transparent material. In an embodiment, the base layer BF includes at least one of glass, reinforced glass, or a synthetic resin film. In an embodiment, the base layer BF is an ultra-thin chemically reinforced glass substrate, such as ultra-thin glass (UTG). When the base layer BF is a chemically reinforced glass substrate, the base layer BF has greater mechanical strength while being thin, and can thus be used as a window of a foldable display device. When the base layer BF includes a synthetic resin film, the base layer BF includes at least one of a polyimide (Pl) film or a polyethylene terephthalate (PET) film. The base layer BF of the window WM may have a multi-layer structure or a single-layer structure. For example, the base layer BF may have a structure in which a plurality of synthetic resin films are bonded through an adhesive member, or a structure in which a glass substrate and a synthetic resin film are bonded through an adhesive. The base layer BF is formed of a flexible material.

The base layer BF has a thickness of about 20 μm to about 100 μm. When the base layer BF has a thickness of less than 20 μm, the base layer BS cannot support the high refractive layer HRL, etc., or protect the lower display module DM (FIG. 3). In addition, when the base layer BF has a thickness of greater than 100 μm, an overall thickness of the display device ED (FIG. 3) increases. For example, when the display devices ED and ED-a are folded as shown in FIGS. 1A to 2B, an increased thickness of the base layer BF can deteriorate folding characteristics.

The high refractive layer HRL is disposed on the base layer BF. The high refractive layer HRL is directly disposed on the base layer BF. A lower surface of the high refractive layer HRL and an upper surface of the base layer BF are in contact. In addition, a lower surface of the base layer BF is adjacent to the display module DM described above (FIG. 3). For example, the high refractive layer HRL is spaced apart from the display module DM (FIG. 3) with the base layer BF therebetween.

In the present description, the term “substituted or unsubstituted” indicates that one is substituted or unsubstituted with at least one substituent selected from a deuterium atom, a halogen atom, a cyano group, a nitro group, an amino group, a silyl group, oxy group, thio group, sulfinyl group, sulfonyl group, carbonyl group, a boron group, a phosphine oxide group, a phosphine sulfide group, an alkyl group, an alkenyl group, an alkynyl group, a hydrocarbon ring group, an aryl group, or a heterocyclic group. In addition, each of the substituents listed above may be substituted or unsubstituted. For example, a biphenyl group may be interpreted as an aryl group or as a phenyl group substituted with a phenyl group.

In the present description, examples of a halogen atom include a fluorine atom, a chlorine atom, a bromine atom, and an iodine atom.

In the present description, an alkyl group may be a linear, branched or cyclic type. The number of carbon atoms in the alkyl group is 1 to 50, 1 to 30, 1 to 20, 1 to 10, or 1 to 6. Examples of the alkyl group include a methyl group, an ethyl group, an n-propyl group, an isopropyl group, an n-butyl group, a s-butyl group, a t-butyl group, an i-butyl group, a 2-ethylbutyl group, a 3,3-a dimethylbutyl group, an n-pentyl group, an i-pentyl group, a neopentyl group, a t-pentyl group, a cyclopentyl group, a 1-methylpentyl group, a 3-methylpentyl group, a 2-ethylpentyl group, a 4-methyl-2-pentyl group, an n-hexyl group, a 1-methylhexyl group, a 2-ethylhexyl group, a 2-butylhexyl group, a cyclohexyl group, a 4-methylcyclohexyl group, a 4-t-butylcyclohexyl group, an n-heptyl group, a 1-methylheptyl group, a 2,2-dimethylheptyl group, a 2-ethylheptyl group, a 2-butylheptyl group, an n-octyl group, a t-octyl group, a 2-ethyloctyl group, a 2-butyloctyl group, a 2-hexyloctyl group, a 3,7-dimethyloctyl group, a cyclooctyl group, an n-nonyl group, an n-decyl group, an adamantyl group, a 2-ethyldecyl group, a 2-butyldecyl group, a 2-hexyldecyl group, a 2-octyldecyl group, an n-undecyl group, an n-dodecyl group, a 2-ethyldodecyl group, a 2-butyldodecyl group, a 2-hexyldocecyl group, a 2-octyldodecyl group, an n-tridecyl group, an n-tetradecyl group, an n-pentadecyl group, an n-hexadecyl group, a 2-ethylhexadecyl group, a 2-butylhexadecyl group, a 2-hexylhexadecyl group, a 2-octylhexadecyl group, an n-heptadecyl group, an n-octadecyl group, an n-nonadecyl group, an n-eicosyl group, a 2-ethyleicosyl group, a 2-butyleicosyl group, a 2-hexyleicosyl group, a 2-octyleicosyl group, an n-heneicosyl group, an n-docosyl group, an n-tricosyl group, an n-tetracosyl group, an n-pentacosyl group, an n-hexacosyl group, an n-heptacosyl group, an n-octacosyl group, an n-nonacosyl group, or an n-triacontyl group, etc., but are not necessarily limited thereto.

In the present description, an aryl group refers to any functional group or substituent derived from an aromatic hydrocarbon ring. The aryl group may be a monocyclic aryl group or a polycyclic aryl group. The number of ring-forming carbon atoms in the aryl group may be 6 to 30, 6 to 20, or 6 to 15. Examples of the aryl group may include a phenyl group, a naphthyl group, a fluorenyl group, an anthracenyl group, a phenanthryl group, a biphenyl group, a terphenyl group, a quaterphenyl group, a quinquephenyl group, a sexiphenyl group, a triphenylenyl group, a pyrenyl group, a benzofluoranthenyl group, a chrysenyl group, etc., but are not limited thereto.

In the present description, a heteroaryl group includes at least one of B, O, N, P, Si, or S as a hetero atom. When a heteroaryl group contains two or more hetero atoms, the two or more hetero atoms may be the same as or different from each other. The heteroaryl group may be a monocyclic heteroaryl group or a polycyclic heteroaryl group. The number of ring-forming carbon atoms in a heteroaryl group may be 2 to 30, 2 to 20, or 2 to 10. Examples of a heteroaryl group include a thiophene group, a furan group, a pyrrole group, an imidazole group, a pyridine group, a bipyridine group, a pyrimidine group, a triazine group, a triazole group, an acridyl group, a pyridazine group, a pyrazinyl group, a quinoline group, a quinazoline group, a quinoxaline group, a phenoxazine group, a phthalazine group, a pyrido pyrimidine group, a pyrido pyrazine group, a pyrazino pyrazine group, an isoquinoline group, an indole group, a carbazole group, an N-arylcarbazole group, an N-heteroarylcarbazole group, an N-alkylcarbazole group, a benzoxazole group, a benzoimidazole group, a benzothiazole group, a benzocarbazole group, a benzothiophene group, a dibenzothiophene group, a thienothiophene group, a benzofuran group, a phenanthroline group, a thiazole group, an isoxazole group, an oxazole group, an oxadiazole group, a thiadiazole group, a phenothiazine group, a dibenzosilole group, or a dibenzofuran group, etc., but are not necessarily limited thereto.

In the present description, (meth)acrylate may refer to acrylate or methacrylate.

A monofunctional or polyfunctional (meth)acrylate monomer may be used as the (meth)acrylate.

The monofunctional(meth)acrylate monomer is one of methyl(meth)acrylate, ethyl(meth)acrylate, propyl(meth)acrylate, n-butyl(meth)acrylate, iso-butyl(meth)acrylate, t-butyl(meth)acrylate, amyl(meth)acrylate, hexyl(meth)acrylate, 2-ethylhexyl(meth)acrylate, octyl(meth)acrylate, nonyl(meth)acrylate, dodecyl(meth)acrylate, hexadecyl(meth)acrylate, octadecyl(meth)acrylate, cyclohexyl(meth)acrylate, methoxyethyl(meth)acrylate, butoxyethyl(meth)acrylate, glycidyl(meth)acrylate, dimethylaminoethyl(meth)acrylate, diethylaminoethyl(meth)acrylate, isobornyl(meth)acrylate, dicyclopentanyl(meth)acrylate, dicyclopentenyl(meth)acrylate, dicyclopentenyloxyethyl(meth)acrylate, 2-hydroxy-3-phenoxypropyl(meth)acrylate, tetrahydrofurfuryl(meth)acrylate, 2-hydroxyethyl(meth)acrylate, phenyl(meth)acrylate, benzyl(meth)acrylate, phenoxyethyl(meth)acrylate, phenoxypropyl(meth)acrylate, nonylphenoxyethyl(meth)acrylate, phenoxydiethylene glycol(meth)acrylate, or phenoxyhydroxypropyl(meth)acrylate, etc., but is not necessarily limited thereto.

The polyfunctional (meth)acrylate may be a 2-functional (meth)acrylate, a 3-functional (meth)acrylate, a 4-functional (meth)acrylate, a 5-functional (meth)acrylate, a 6-functional (meth)acrylate, a 7-functional (meth)acrylate, an 8-functional (meth)acrylate, or a 9-functional (meth)acrylate. For example, the polyfunctional (meth)acrylate may be a 2-functional (meth)acrylate such as one of an ethylene glycol di(meth)acrylate, diethylene glycol di(meth)acrylate, triethylene glycol di(meth)acrylate, butylene glycol di(meth)acrylate, neopentyl glycol di(meth)acrylate, propylene glycol di(meth)acrylate, 1,3-butanediol di(meth)acrylate, 1,4-butanediol di(meth)acrylate, or 1,6-hexanediol di(meth)acrylate, a 3-functional (meth)acrylate such as one of trimethylolpropane tri(meth)acrylate, trimethylolethane tri(meth)acrylate, trimethylolethanol tri(meth)acrylate, or trimethylolmethane tri(meth)acrylate, a 4-functional (meth)acrylate such as pentaerythritol tetra(meth)acrylate, a 5-functional (meth)acrylate such as dipentaerythritol penta(meth)acrylate, a 6-functional (meth)acrylate such as dipentaerythritol hexa(meth)acrylate, a 7-functional (meth)acrylate such as tripentaerythritol hepta(meth)acrylate, a 8-functional (meth)acrylate such as tripentaerythritol octa(meth)acrylate or tetrapentaerythritol octa(meth)acrylate, or a 9-functional (meth)acrylate such as tetrapentaerythritol nona(meth)acrylate, etc., but is not necessarily limited thereto.

In the present description, a fluoroalkyl group refers to an alkyl group in which at least one hydrogen atom is substituted with a fluorine atom. The number of carbon atoms in the fluoroalkyl group may be 1 to 30, 1 to 20, or 1 to 10.

In the present description, a perfluoroalkyl group refers to an alkyl group in which all hydrogen atoms of an alkyl group are substituted with fluorine atoms. The perfluoroalkyl group may be included in the fluoroalkyl group. The number of carbon atoms in the perfluoroalkyl group may be 1 to 30, 1 to 20, or 1 to 10. The perfluoroalkyl group may have a structure of Formula F-1 below, but is not limited thereto.

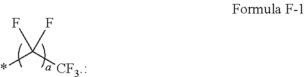

In Formula F-1, a is an integer of 0 to 30.

In the present description, “ [symbol] ” refers to a site to be connected.

The high refractive layer HRL includes inorganic particles INP and a base resin BS. The inorganic particles INP are dispersed in the base resin BS. The base resin BS includes at least one of a (meth)acrylic resin, a urethane-based resin, a fluorine-based resin, an epoxy-based resin, a polyester-based resin, a polyamide-based resin, or a silicone-based resin, or a combination thereof.

In an embodiment, the base resin BS includes a (meth)acrylate-based resin. The high refractive layer HRL is formed from a resin composition that includes the inorganic particles INP and a (meth)acrylate monomer or oligomer. The high refractive layer HRL is formed by providing a resin composition on the base layer BF through a method such as coating, and curing the resin composition. The high refractive layer HRL may be formed by thermosetting or photocuring a resin composition. In an embodiment, the high refractive layer HRL is formed by photocuring. Accordingly, the base resin BS includes a polymer derived from a resin composition that includes a (meth)acrylate monomer or oligomer.

In an embodiment, the base resin BS in the high refractive layer HRL includes a polymer derived from a resin composition that includes polyfunctional (meth)acrylate. For example, the base resin BS includes a polymer derived from a resin composition that includes at least one of 3-functional (meth)acrylate, 6-functional (meth)acrylate, or 9-functional (meth)acrylate. Since the base resin BS includes a (meth)acrylate-based resin, the window WM has greater hardness and impact resistance. In addition, the high refractive layer HRL according to an embodiment protects the window WM from external impact or chemical damage.

The high refractive layer HRL according to an embodiment includes the inorganic particles INP. The inorganic particles INP increase the hardness of the high refractive layer HRL according to an embodiment. In an embodiment, the inorganic particles INP include at least one of niobium oxide or zirconium oxide. When the high refractive layer HRL includes at least one of niobium oxide or zirconium oxide, the high refractive layer HRL has greater hardness and exhibits a desired refractive index range to sufficiently exhibit low reflection characteristics.

In an embodiment, the inorganic particles INP are present in an amount of about 5 wt % to about 25 wt % with respect to a total weight of the high refractive layer HRL. When the amount of the inorganic particles INP in the high refractive layer HRL satisfies the above range, the high refractive layer HRL exhibits low reflection characteristics and has increased mechanical durability as well. For example, when the inorganic particles INP in the high refractive layer HRL are present in an amount of about 5 wt % to about 25 wt % with respect to the entire high refractive layer HRL, the window WM of an embodiment exhibits further increased optical properties and durability.

When the amount of the inorganic particles INP is less than 5 wt % with respect to the total weight of the high refractive layer HRL, the high refractive layer HRL has a lower refractive index value, and has a poorer light extraction function in relation to other members. In addition, with respect to the total weight of the high refractive layer HRL, when the amount of the inorganic particles INP is greater than 25 wt %, the inorganic particles INP in the high refractive layer HRL increase the brittleness of the high refractive layer HRL, resulting in reduced flexural strength.

The high refractive layer HRL has a higher refractive index than the low refractive layer LRL. The high refractive layer HRL has a refractive index of about 1.55 to about 1.65. Since the refractive index of the high refractive layer HRL satisfies the above range, the window WM has reduced surface reflectance.

The inorganic particles INP have an average diameter of 200 nm or less. For example, the inorganic particles INP have an average diameter of about 10 nm to about 200 nm. When the average diameter of the inorganic particles INP is set to about 10 nm to about 200 nm, the high refractive layer HRL has optimized thickness and refractive index values.

In an embodiment, the high refractive layer HRL has a thickness d H of about 2000 nm to about 7000 nm. When the high refractive layer HRL has a thickness range of about 2000 nm to about 7000 nm, the window WM according to an embodiment exhibits high transmittance and low reflectance. In addition, the window WM of an embodiment that includes the high refractive layer HRL in a thickness range of about 2000 nm to about 7000 nm has excellent impact resistance and increased durability.

The low refractive layer LRL is disposed on the high refractive layer HRL. The low refractive layer LRL is directly disposed on the high refractive layer HRL. A lower surface of the low refractive layer LRL and an upper surface of the high refractive layer HRL are in contact. The high refractive layer HRL is interposed between the low refractive layer LRL and the base layer BS. However, embodiments of the inventive concept are not necessarily limited thereto.

The refractive index of the low refractive layer LRL is regulated by combining the refractive index of the high refractive layer HRL and the base layer BF such that the reflectance of the entire window WM is 3.9% or less at a wavelength of about 380 nm to about 780 nm. The window WM according to an embodiment that includes the low refractive layer LRL has a reflectance of 3.9% or less with respect to light that has a wavelength of about 380 nm to about 780 nm. For example, the window WM has a reflectance of about 1.0% to about 3.9% with respect to light in a wavelength range of about 380 nm to about 780 nm.

The low refractive layer LRL has a lower refractive index than the high refractive layer HRL, and for example, the low refractive layer LRL has a refractive index of about 1.40 to about 1.45. However, embodiments of the inventive concept are not necessarily limited thereto, and the refractive index of the low refractive layer LRL is regulated within a range so that the window WM maintains a low reflectance of 3.9% or less.

The window WM according to an embodiment of the inventive concept includes a two-layer structure in which a layer that has a relatively high refractive index and a layer that has a relatively low refractive index are sequentially stacked in the third direction DR3. Accordingly, an increased anti-reflection effect may be achieved.

The low refractive layer LRL includes a fluorine-containing silsesquioxane-based resin. In an embodiment, the fluorine-containing silsesquioxane-based resin is a silsesquioxane-based resin that includes at least one fluorine atom.

In an embodiment, the fluorine-containing silsesquioxane-based resin is a silsesquioxane-based resin that includes at least one fluoroalkyl group or at least one perfluoroalkyl group. In an embodiment, the fluorine-containing silsesquioxane-based resin is one in which a fluoroalkyl group or a perfluoroalkyl group is directly substituted on a silicon atom of a silsesquioxane resin. The fluoroalkyl group or perfluoroalkyl group is linked to a silsesquioxane skeleton, and thus increases the free volume in a polymer. Accordingly, the fluorine-containing silsesquioxane-based resin of an embodiment into which a fluoroalkyl group or a perfluoroalkyl group is introduced exhibits a lower refractive index than a typical silsesquioxane-based resin without fluorine.

In an embodiment, the fluorine-containing silsesquioxane-based resin includes at least one of a (meth)acrylate group or an epoxy group. For example, in the fluorine-containing silsesquioxane-based resin, a (meth)acrylate group or an epoxy group is directly substituted on a silicon atom of a silsesquioxane resin, or a (meth)acrylate group or an epoxy group is substituted on a substituent substituted on a silicon atom. In this case, the substituent may be a substituted or unsubstituted alkoxy group that has 1 to 10 carbon atoms.

In an embodiment, the fluorine-containing silsesquioxane-based resin includes at least two substituents. The fluorine-containing silsesquioxane-based resin includes a first substituent and a second substituent. In an embodiment, the first substituent may be a substituted or unsubstituted fluoroalkyl group that has 1 to 20 carbon atoms, or a substituted or unsubstituted perfluoroalkyl group that has 1 to 20 carbon atoms. The second substituent may be a substituted or unsubstituted (meth)acrylate group, or an alkoxy group that has 1 to 10 carbon atoms substituted with an epoxy group. The fluorine-containing silsesquioxane-based resin includes a silsesquioxane resin, and has a structure in which the first substituent is substituted on a first silicon atom of the silsesquioxane resin and the second substituent is substituted on a second silicon atom. In an embodiment, the fluorine-containing silsesquioxane-based resin has a structure in which a perfluoroalkyl group that has 1 to 20 carbon atoms is substituted on a first silicon atom in a silsesquioxane resin, and a substituted or unsubstituted (meth)acrylate group is substituted on a second silicon atom. In an embodiment, the fluorine-containing silsesquioxane-based resin has a structure in which a perfluoroalkyl group that has 1 to 20 carbon atoms is substituted on a first silicon atom in a silsesquioxane resin, and an alkoxy group that has 1 to 10 carbon atoms substituted with an epoxy group is substituted on a second silicon atom.

In the present description, an alkoxy group that has 1 to 10 carbon atoms substituted with an epoxy group is represented by Formula E below.

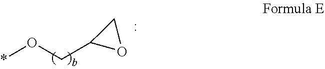

In Formulas E, b is an integer of 1 to 10.

In Formula E, [symbol] is a site connected to a silicon atom of the fluorine-containing silsesquioxane-based resin.

In an embodiment, the fluorine-containing silsesquioxane-based resin includes a repeating unit represented by Formula 1 below.

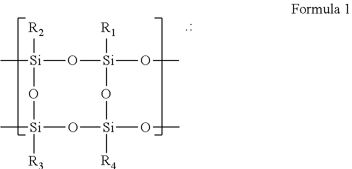

In Formula 1, R₁ to R₄ are each independently one of a hydrogen atom, a deuterium atom, a halogen atom, a substituted or unsubstituted alkyl group that has 1 to 20 carbon atoms, a substituted or unsubstituted (meth)acrylate group, a substituted or unsubstituted aryl group that has 6 to 30 carbon atoms, an alkoxy group that has 1 to 10 carbon atoms substituted with an epoxy group, or a substituted or unsubstituted heteroaryl group that has 2 to 30 carbon atoms.

In Formula 1, at least one of R₁ to R₄ is a substituted or unsubstituted fluoroalkyl group that has 1 to 20 carbon atoms, or a substituted or unsubstituted perfluoroalkyl group that has 1 to 20 carbon atoms, and at least another one of R₁ to R₄ is a substituted or unsubstituted (meth)acrylate group, or an alkoxy group that has 1 to 10 carbon atoms substituted with an epoxy group.

In an embodiment, one of R₁ to R₄ is a substituted or unsubstituted fluoroalkyl group that has 1 to 20 carbon atoms, or a substituted or unsubstituted perfluoroalkyl group that has 1 to 20 carbon atoms, and the others may be a substituted or unsubstituted (meth)acrylate group, or an alkoxy group that has 1 to 10 carbon atoms substituted with an epoxy group. In an embodiment, two of R₁ to R₄ are a substituted or unsubstituted fluoroalkyl group that has 1 to 20 carbon atoms, or a substituted or unsubstituted perfluoroalkyl group that has 1 to 20 carbon atoms, and the other two are a substituted or unsubstituted (meth)acrylate group, or an alkoxy group that has 1 to 10 carbon atoms substituted with an epoxy group. In an embodiment, three of R₁ to R₄ are a substituted or unsubstituted fluoroalkyl group, or a substituted or unsubstituted perfluoroalkyl group, and the other one is a substituted or unsubstituted (meth)acrylate group, or an alkoxy group that has 1 to 10 carbon atoms substituted with an epoxy group.

In an embodiment, a fluorine-containing silsesquioxane-based resin is represented by Formula 1-1 below.

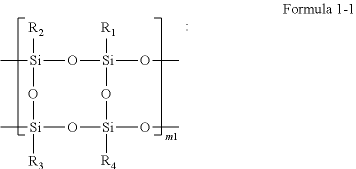

In Formula 1-1, ml is an integer of 1 to 10,000.

In Formula 1-1, the descriptions of Formula 1 apply to R₁ to R₄.

In an embodiment, the fluorine-containing silsesquioxane-based resin includes a repeating unit represented by Formula 2 below.

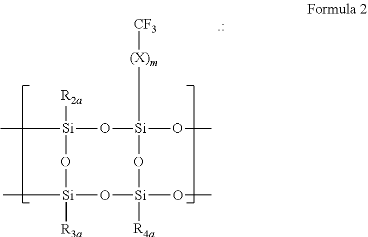

Formula 2 shows a case where the type of R₁ in Formula 1 is specified. Formula 2 shows a case in which R₁ of Formula 1 is a perfluoroalkyl group that has 2 to 12 carbon atoms.

In Formula 2, X is —CF₂—. That is, X is a difluoromethylene group.

In Formula 2, m is an integer of 1 to 11.

In Formula 2, R₂ₐ to R₄ₐ are each independently a substituted or unsubstituted fluoroalkyl group that has 1 to 20 carbon atoms, a substituted or unsubstituted perfluoroalkyl group that has 1 to 20 carbon atoms, a substituted or unsubstituted (meth)acrylate group, or an alkoxy group that has 1 to 10 carbon atoms substituted with an epoxy group

In Formula 2, at least one of R₂ₐ to R₄ₐ is a substituted or unsubstituted (meth)acrylate group, or an alkoxy group that has 1 to 10 carbon atoms substituted with an epoxy group. In an embodiment, all of R₂ₐ to R₄ₐ are a substituted or unsubstituted (meth)acrylate group. In an embodiment, all of R₂ₐ to R₄ₐ are an alkoxy group that has 1 to 10 carbon atoms substituted with an epoxy group. However, embodiments of the inventive concept are not necessarily limited thereto, and in an embodiment, one of R₂ₐ to R₄ₐ is a (meth)acrylate group, and the others are an alkoxy group that has 1 to 10 carbon atoms substituted with an epoxy group. In an embodiment, two of R₂ₐ to R₄ₐ are a (meth)acrylate group, and the other one is an alkoxy group that has 1 to 10 carbon atoms substituted with an epoxy group.

In Formula 2, substituents represented by R₂ₐ to R₄ₐ are each independently represented by Formula 3-1 or Formula 3-2 below.

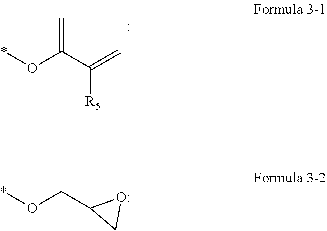

In Formula 3-1, R₅ is a hydrogen atom or a substituted or unsubstituted methyl group.

In Formulas 3-1 and 3-2, [symbol] is a site connected to Si of Formula 2 above.

In an embodiment, the fluorine-containing silsesquioxane-based resin is represented by Formula 2-1 below.

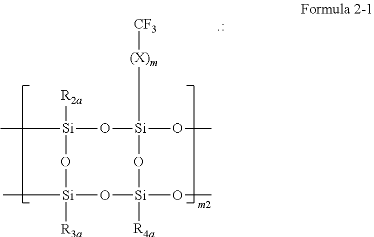

In Formula 2-1, m2 is an integer of 1 to 10,000.

In Formula 2-1, the descriptions of Formula 2 apply to R₂ₐ to R₄ₐ, X, and m.

In an embodiment, the fluorine-containing silsesquioxane-based resin is represented by one of Formula 4-1 or Formula 4-2 below.

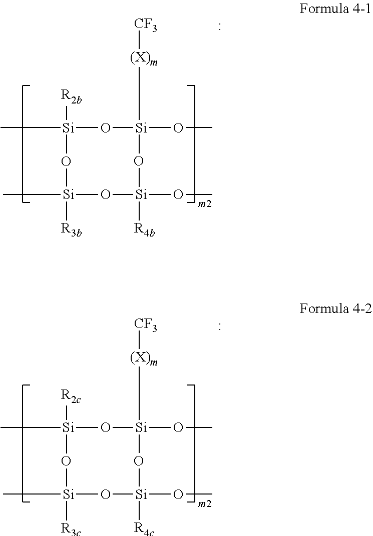

Formulas 4-1 and 4-2 show cases in which the types of R₁ to R₄ in Formula 1 are specified. Formula 4-1 shows a case in which R₁ of Formula 1 is a perfluoroalkyl group that has 1 to 12 carbon atoms, and R₂ to R₄ are each independently a substituted or unsubstituted (meth)acrylate group. Formula 4-2 shows a case in which R₁ of Formula 1 is a perfluoroalkyl group that has 1 to 12 carbon atoms, and R₂ to R₄ are each independently an alkoxy group that has 1 to 10 carbon atoms substituted with an epoxy group.

In Formula 4-1, R_{2b} to R_{4b} are each independently a substituted or unsubstituted (meth)acrylate group. In an embodiment, R_{2b} to R_{4b} are each independently represented by Formula 3-1 above.

In Formula 4-2, R_{2c} to R_{4c} are each independently an alkoxy group that has 1 to 10 carbon atoms substituted with an epoxy group. In an embodiment, R_{2c} to R_{4c} are each independently represented by Formula 3-2 above.

In Formulas 4-1 to 4-2, the descriptions of Formulas 2 and 2-1 apply to X, m, and m2.

In an embodiment, the fluorine-containing silsesquioxane-based resin has a ladder structure. When the fluorine-containing silsesquioxane-based resin has a ladder structure, the fluorine-containing silsesquioxane-based resin generates less aggregation than a silsesquioxane-based resin that has a cage structure, and a surface roughness of a low refractive layer is reduced. Accordingly, a decrease in wear resistance due to an increase in surface roughness is prevented.

In an embodiment, the low refractive layer LRL has a thickness d_{L} of about 50 nm to about 150 nm. In an embodiment, the low refractive layer LRL has a thickness d_{L} of about 80 nm to about 120 nm. When the low refractive layer LRL has a thickness range of about 50 nm to about 150 nm, the window WM according to an embodiment exhibits high transmittance and low reflectance. In addition, the window WM of an embodiment that includes the low refractive layer LRL in a thickness range of about 50 nm to about 150 nm has excellent impact resistance and increased durability.

In an embodiment, the low refractive layer LRL does not include inorganic particles. For example, the low refractive layer LRL does not include silica particles such as silica beads or hollow silica. Since the low refractive layer LRL does not include inorganic particles, the surface roughness of the low refractive layer LRL is reduced, and oscillating wear resistance is increased.

In the window WM of an embodiment, the anti-reflection film PL includes the low refractive layer LRL that contains a fluorine-containing silsesquioxane-based resin, and exhibits low reflection, anti-fingerprint, wear resistance, and chemical resistance properties. The window WM of an embodiment includes a base layer BF, a high refractive layer HRL disposed on the base layer BF that includes inorganic particles and a base resin BS, and a low refractive layer LRL that includes a fluorine-containing silsesquioxane-based resin disposed on the high refractive layer HRL, and has excellent optical properties, excellent durability, and satisfactory folding properties all together.

A method of inducing destructive interference in each layer includes stacking a plurality of layers with different refractive indices on a window to minimize external light reflection. For example, for the low refractive layer in the window, a method includes adding inorganic particles such as hollow silica to obtain low refractive properties. However, when inorganic particles are used, the inorganic particles increase roughness on an outer surface of the low refractive layer and deteriorate wear resistance of the window.

According to an embodiment of the inventive concept, the window of an embodiment has a structure in which a high refractive layer and a low refractive layer are sequentially stacked on a base layer, and the low refractive layer includes a fluorine-containing silsesquioxane-based resin. Accordingly, even without introducing additional inorganic particles, reflectance of the low refractive layer is reduced and wear resistance is increased as well. Therefore, when a window according to an embodiment is attached to a display device, reflection of externally incident light is effectively reduced and mechanical durability is increased, and thus a display device with increased reliability is provided.

FIG. 6 is a cross-sectional view of a window according to an embodiment of the inventive concept. FIG. 6 shows a window WM-1 of an embodiment that differs from the window WM shown in FIG. 5. The window WM-1 of an embodiment shown in FIG. 6 is a cover window of the display devices ED and ED-a of an embodiment described with reference to FIGS. 1A to 4. Hereinafter, in the description of the window WM-1 according to an embodiment of the present invention shown in FIG. 6, descriptions of components described with reference to FIG. 5 will be omitted and differences will be described in detail.

Referring to FIG. 6, in an embodiment, the window WM-1 includes a base layer BF and an anti-reflection film PL-1 disposed on the base layer BF. The antireflection film PL-1 shown in FIG. 6 further includes a functional layer AF disposed on a low refractive layer LRL, as compared to the antireflection film PL shown in FIG. 5. In addition, the antireflection film PL-1 further includes an adhesive layer PM disposed between the low refractive layer LRL and the functional layer AF. For example, the window WM-1 shown in FIG. 6 differs from the window WM shown in FIG. 5 in that the window WM-1 further includes the functional layer AF and the adhesive layer PM. For those functional layers in the window WM-1 according to an embodiment shown in FIG. 6 that are also shown in FIG. 5, the above descriptions of the functional layers in the window WM of FIG. 5 equally apply.

In an embodiment, the functional layer AF is disposed on the low refractive layer LRL. The functional layer AF is disposed on an upper surface of the adhesive layer PM. In an embodiment, the functional layer AF is directly disposed on an upper surface of the adhesive layer PM. The functional layer AF is an uppermost layer of the window WM-1, and the upper surface of the functional layer AF defines the uppermost surface of the window WM-1.

The functional layer AF may be formed of a single layer or a plurality of layers. The functional layer AF includes at least one of a hard coating layer, an anti-fingerprint layer, or an anti-scattering layer. In an embodiment, the functional layer AF includes a fluorine-containing compound. For example, the functional layer AF includes a perfluoropolyether (PFPE) compound. For example, the functional layer AF includes a silane compound that contains perfluoropolyether. In an embodiment, the functional layer AF that includes the fluorine-containing compound is an anti-fingerprint layer.

The functional layer AF has a thickness of about 10 nm to about 20 nm. When the thickness of the functional layer AF is about 10 nm to about 20 nm, the functional layer AF exhibits excellent antifouling properties and excellent durability properties together.

The adhesive layer PM is disposed on the low refractive layer LRL. The adhesive layer PM is disposed between the low refractive layer LRL and the functional layer AF and thus increases bonding strength between the low refractive layer LRL and the functional layer AF. For example, the adhesive layer PM is an auxiliary layer that increases the bonding strength between the low refractive layer LRL and the functional layer AF. The adhesive layer PM is directly disposed on the low refractive layer LRL.

In an embodiment, the adhesive layer PM includes a silane coupling agent. For example, the adhesive layer PM includes an amino silane compound as the silane coupling agent. Since the adhesive layer PM includes the silane coupling agent, adhesive strength between the low refractive layer LRL and the functional layer AF is increased. The adhesive layer PM includes the silane coupling agent to increase bonding strength with neighboring layers, and prevents damage to the window WM-1 even against oscillating wear or chemical exposure. In addition, the adhesive layer PM includes the silane coupling agent to increase adhesive strength of the functional layer AF, and maintains hydrophobicity of the functional layer AF even against oscillating wear.

In an embodiment, the adhesive layer PM has a thickness of about 10 nm to about 15 nm. When the thickness of the adhesive layer PM satisfies the above range, the low refractive layer LRL and the functional layer AF can be sufficiently bonded without increasing the overall thickness of the window WM-1.

In the window WM-1 of an embodiment, the low refractive layer LRL according to an embodiment that includes the fluorine-containing silsesquioxane-based resin has an initial water contact angle of 95° or less on an exposed surface. For example, the low refractive layer LRL has an initial water contact angle of 90° or less on an exposed surface. The initial water contact angle of the low refractive layer LRL is regulated according to an amount of fluorine \in the fluorine-containing silsesquioxane-based resin. When the initial water contact angle of the low refractive layer LRL satisfies the above-mentioned range, the bonding strength between the low refractive layer LRL and the upper adhesive layer PM is increased, and the window WM-1 of an embodiment has increased oscillating wear resistance.

In the window WM-1 according to an embodiment, the window WM-1 has a surface reflectance of 3.9% or less at a wavelength of about 380 nm to about 780 nm. In the window WM-1 according to an embodiment, the functional layer AF is disposed on an uppermost layer, and reflectance on an upper surface of the functional layer AF is 3.9% or less at a wavelength of about 380 nm to about 780 nm. At a wavelength of about 380 nm to about 780 nm, the reflectance on the upper surface of the functional layer AF is about 1.0% to about 3.9%. In the present description, the “reflectance” of the window WM-1 is defined as a ratio of light reflected with respect to external light incident in an inner direction of the window WM-1. The reflected light includes both specularly reflected light that is reflected at the same angle and diffusing reflected light that is scattered and reflected in various directions. For example, in the present description, the reflectance is defined as specular component included (SCI) reflectance.

Hereinafter, a window according to an embodiment and a display device including the same will be described in more detail through Examples and Comparative Examples. However, the following Examples and Comparative Examples are presented for describing the inventive concept in more detail, and embodiments of the inventive concept are not necessarily limited to the following Examples and Comparative Examples.

### EXAMPLES

### 1. Manufacture of Window

Physical properties of windows from Examples 1 and 2 and Comparative Examples 1 to 4 are compared and shown in Table 1 below. Examples 1 and 2 and Comparative Examples 1 to 4 all correspond to windows in which a base layer, a high refractive layer, a low refractive layer, an adhesive layer, and a functional layer are sequentially stacked. In the windows of Examples 1 and 2 and Comparative Examples 1 to 4, the base layer, the adhesive layer, and the functional layer are the same in configuration, and the high refractive layer and the low refractive layer differ in configuration.

### Example 1

A window that includes a stack structure shown in FIG. 6 was manufactured. The high refractive layer of Example 1 includes an acrylate-based resin as a base resin and zirconium oxide (ZrO₂) as inorganic particles. In Example 1, zirconium oxide is present in an amount of 5 wt % with respect to a total weight of the high refractive layer. In addition, the low refractive layer of Example 1 includes a fluorine-containing silsesquioxane-based resin that contains fluorine and an epoxy group.

### Example 2

The window of Example 2 differs from that of Example 1 in that the fluorine-containing silsesquioxane-based resin in the low refractive layer includes an acrylate group instead of an epoxy group.

### Comparative Example 1

Comparative Example 1 differs from Example 1 in that the high refractive layer does not include inorganic particles, and the low refractive layer includes a silsesquioxane-based resin without fluorine, and hollow silica. For example, Comparative Example 1 uses an epoxy group-containing silsesquioxane-based resin without fluorine, as compared to Example 1.

### Comparative Example 2

Comparative Example 2 differs from Example 1 in that the high refractive layer does not include inorganic particles, and the low refractive layer includes an acrylate-based resin and hollow silica.

### Comparative Example 3

Comparative Example 3 differs from Example 2 in that the high refractive layer does not include inorganic particles, and the low refractive layer includes a silsesquioxane-based resin without fluorine. For example, Comparative Example 3 uses an acrylate group-containing silsesquioxane-based resin without fluorine, as compared to Example 2.

### Comparative Example 4

Comparative Example 4 differs from Example 2 in that zirconium oxide is present in an amount of 25 wt % with respect to a total weight of the high refractive layer, and the low refractive layer includes a silsesquioxane-based resin without fluorine. For example, Comparative Example 4 uses an acrylate group-containing silsesquioxane-based resin without fluorine, as compared to Example 2.

### 2. Window Evaluation 1

For evaluation of windows according to Examples 1 and 2 and Comparative Examples 1 to 4, reflectance and wear resistance were evaluated. Each evaluation method is as follows.

### (1) Reflectance

The reflectance was measured using a CM-3700A (KONICA MINOLTA) instrument. The reflectance was measured using D65 light source at a 2° viewing angle.

### (2) Wear Resistance

Wear resistance may also be referred to as eraser wear resistance. Wear resistance was evaluated by visually observing a surface after a wear test with an eraser.

The window to be evaluated was cut to a size of 7 cm×8 cm and fixed to a jig of a wear resistance measuring device (Daesung Precision Co., Ltd., scratch tester), and an eraser (Minoan, Rubber stick) having a diameter of 6 mm was applied and fixed on the TIP. A moving distance of 15 mm, a moving rate of 50 rpm, and a load of 1.0 kg were set, and the eraser was reciprocally rubbed on a surface of an anti-fingerprint layer of the test window to visually observe and evaluate the surface condition.

TABLE 1

| | | | Comparative | Comparative | Comparative | Comparative |
|---|---|---|---|---|---|---|
| | Example 1 | Example 2 | Example 1 | Example 2 | Example 3 | Example 4 |
| Reflectance (%) | ≤3.5 | ≤3.5 | <2.6 | <3.0 | >4.4 | >3.9 |
| Wear resistance | 5000 | 4000 | 500 | 500 | >6000 | >6000 |
| (Number of times) | | | | | | |

Table 1 shows the results of evaluating reflectance and wear resistance properties of the windows of Examples 1 and 2 and Comparative Examples 1 to 4.

The window of Comparative Example 1 includes a high refractive layer that contains an acrylic resin, and a low refractive layer that contains an epoxy group-containing silsesquioxane-based resin and hollow silica. The window of Comparative Example 2 includes a high refractive layer that contains an acrylic resin, and a low refractive layer that contains an acrylic resin and hollow silica.

Comparing Examples 1 and 2 with Comparative Examples 1 and 2, Comparative Examples 1 and 2 exhibited a low reflectance of 3.0% or less by including hollow silica in the low refractive layer, but were observed to have a damaged surface after 500 cycles of reciprocating rubbings in the wear resistance test, thereby exhibiting significantly lower wear resistance as compared to Examples 1 and 2. This is believed to be because Comparative Examples 1 and 2 were provided with hollow silica in the low refractive layer to obtain a low reflection effect through a combination with the high refractive layer without applying separate inorganic particles to the high refractive layer, but had increased surface roughness of the low refractive layer due to hollow silica, leading to lower oscillating wear resistance.

Comparative Example 3 includes a high refractive layer that contains an acrylic resin, and a low refractive layer that contains an acrylate group-containing silsesquioxane-based resin.

Comparing Examples 1 and 2 with Comparative Example 3, Comparative Example 3 includes a silsesquioxane-based resin without fluorine in the low refractive layer, and exhibited satisfactory surface properties even after 6000 cycles of reciprocating rubbings in the wear resistance test. However, Comparative Example 3 has a reflectance of greater than 4.4% that reduces anti-reflection of external light as compared to Examples 1 and 2. As in Comparative Example 3, when a silsesquioxane-based resin that contains an acrylate group but not fluorine is applied to the low refractive layer, the wear resistance is increased as compared to Comparative Examples 1 and 2 in which hollow silica is applied to the low refractive layer, but low refractive properties are essentially unaffected in the combination with the high refractive layer, leading to less reduction in reflectance.

Comparative Example 4 includes a high refractive layer that contains an acrylic resin and zirconium oxide, and a low refractive layer that contains an acrylate group-containing silsesquioxane-based resin.

Comparing Examples 1 and 2 with Comparative Example 4, Comparative Example 4 exhibited satisfactory surface properties even after 6000 cycles in the wear resistance test. However, Comparative Example 4 has a reflectance of greater than 3.9%, which reduces anti-reflection of external light as compared to Examples 1 and 2. Compared to Comparative Example 3, Comparative Example 4 has an increased refractive index of the high refractive layer by introducing zirconium oxide into the high refractive layer to increase destructive interference in the high refractive layer and the low refractive layer. However, in Comparative Example 4, when the low refractive layer includes the acrylate group-containing silsesquioxane-based resin alone without hollow silica, low refractive properties are essentially unaffected, and there are limits on the desired reflectance even when inorganic particles are introduced into the high refractive layer for refractive index matching.

Comparing Examples 1 and 2 with Comparative Examples 1 to 4, Example 1 and Example 2 exhibit a low reflectance of 3.5% or less, and were observed to have a damaged surface after 5000 cycles and 4000 cycles of reciprocating rubbings in the wear resistance test, thereby exhibiting satisfactory wear resistance. For example, the window of Examples 1 and 2 exhibits both low reflection and increased oscillating wear resistance. For example, comparing Examples 1 and 2 with Comparative Examples 1 and 2, in an embodiment in which the low refractive layer includes the fluorine-containing silsesquioxane-based resin of an embodiment, excellent optical effects, such as low refractive properties, are obtained even when no inorganic particles are included, and wear resistance properties are increased as surface roughness caused by hollow silica is suppressed.

In addition, comparing Examples 1 and 2 with Comparative Examples 3 and 4, the window of Examples 1 and 2 includes a fluorine-containing silsesquioxane-based resin that exhibits excellent wear resistance properties at a level similar to that of Comparative Examples 3 and 4, which include an acrylate group-containing silsesquioxane-based resin, and achieves a greater lower reflection effect than Comparative Example 3 and Comparative Example 4. For example, referring to Examples 1 and 2 and Comparative Example 4, Comparative Example 4 does not achieve desired reflectance even when 25 wt % of inorganic particles are introduced into the high refractive layer for refractive index matching, while Examples 1 and 2 have increased reflectance reduction due to greater interference effect in the refractive index combination by introducing a fluorine-containing silsesquioxane-based resin into the low refractive layer, even when no or few inorganic particles are introduced into the high refractive layer.

### 3. Window Evaluation 2

Table 2 shows evaluation results for the windows of Examples 1 and 2. In Table 2, crack strain indicates a level of increase in the size of a sample after extending an initial test sample. The test sample for crack strain measurement was prepared by laser cutting the sample into a size of 1.0 cm×10 cm. An extension rate was set to 10 mm/min, and after extension was applied, the presence of cracks was determined using a microscope, and an increase in the sample size at the point was evaluated.

TABLE 2

| Item | Example 1 | Example 2 |
|---|---|---|
| Crack strain (%) | 5 | 5 |

Referring to Table 2, Examples 1 and 2 were measured to have a crack strain value of 5%. Referring to Tables 1 and 2 together, Examples 1 and 2, which include a fluorine-containing silsesquioxane-based resin in a low refractive layer, exhibit excellent wear resistance and high crack strain values as well. For example, the window of Examples 1 and 2 exhibit excellent optical properties and excellent mechanical durability by including a fluorine-containing silsesquioxane-based resin in the low refractive layer.

A window of a display device should exhibit excellent mechanical properties to protect the display device from external stimuli and to provide low reflection properties that minimize reflection of externally incident light. For example, a window disposed on an upper portion of the display device can receive external contacts, and thus can be scratched or worn, and accordingly, high oscillating wear resistance, etc., are desired.

In an embodiment of the inventive concept, a high refractive layer and a low refractive layer that have different refractive indices are includes in a window disposed on a display device to obtain an anti-reflection effect, and also a fluorine-containing silsesquioxane-based resin is introduced into a low refractive layer to prevent deterioration of mechanical properties and increase durability properties. The fluorine-containing silsesquioxane-based resin has fluorine introduced into a silsesquioxane skeleton, and has lower refractive properties than typical silsesquioxane-based resins and exhibits excellent mechanical properties.

According to an embodiment of the inventive concept, a window includes a base layer, a high refractive layer that includes inorganic particles and a base resin, and a low refractive layer that includes a fluorine-containing silsesquioxane-based resin, and thus exhibits low reflection properties and excellent wear resistance. Accordingly, a display device that includes the window has increased optical properties and durability. Although embodiments of the present disclosure has been described with reference to drawings thereof, it will be understood that embodiments of the inventive concept should not be limited to described embodiments but various changes and modifications can be made by those skilled in the art without departing from the spirit and scope of embodiments of the present disclosure. Accordingly, the technical scope of embodiments of the inventive concept is not intended to be limited to the contents set forth in the detailed description of the specification, but is intended to be defined by the appended claims.

What is claimed is:

1. A window, comprising:
a base layer;
a high refractive layer disposed on the base layer, wherein the high refractive layer includes inorganic particles and a base resin; and
a low refractive layer disposed on the high refractive layer, wherein the low refractive layer includes a fluorine-containing silsesquioxane-based resin.

2. The window of claim 1, wherein the fluorine-containing silsesquioxane-based resin is a silsesquioxane-based resin that includes at least one perfluoroalkyl group.

3. The window of claim 1, wherein the fluorine-containing silsesquioxane-based resin comprises at least one of a (meth)acrylate group or an epoxy group.

4. The window of claim 1, wherein the fluorine-containing silsesquioxane-based resin comprises a repeating unit represented by Formula 1 below: 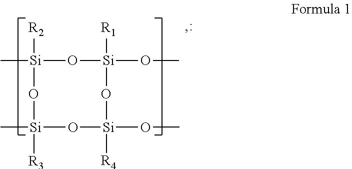
wherein in Formula 1,
R₁ to R₄ are each independently one of a hydrogen atom, a deuterium atom, a halogen atom, a substituted or unsubstituted alkyl group, a substituted or unsubstituted (meth)acrylate group, a substituted or unsubstituted aryl group that has 6 to 30 carbon atoms, an alkoxy group that has 1 to 10 carbon atoms substituted with an epoxy group, or a substituted or unsubstituted heteroaryl group that has 2 to 30 carbon atoms, and
at least one of R₁ to R₄ is a substituted or unsubstituted fluoroalkyl group, or a substituted or unsubstituted perfluoroalkyl group, and at least another one of R₁ to R₄ is a substituted or unsubstituted (meth)acrylate group, or an alkoxy group that has 1 to 10 carbon atoms substituted with an epoxy group.

5. The window of claim 1, wherein the fluorine-containing silsesquioxane-based resin comprises a repeating unit represented by Formula 2 below: 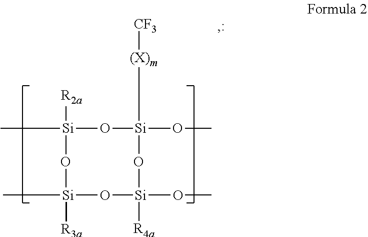
wherein in Formula 2,
X is —CF₂—,
m is an integer that is greater than or equal to 1 and less than or equal to 11,
R₂ₐ to R₄ₐ are each independently one of a substituted or unsubstituted fluoroalkyl group, a substituted or unsubstituted perfluoroalkyl group, a substituted or unsubstituted (meth)acrylate group, or an alkoxy group that has 1 to 10 carbon atoms substituted with an epoxy group, and
at least one of R₂ₐ to R₄ₐ is a substituted or unsubstituted (meth)acrylate group, or an alkoxy group that has 1 to 10 carbon atoms substituted with an epoxy group.

6. The window of claim 5, wherein R₂ₐ to R₄ₐ are each independently represented by one of Formula 3-1 or Formula 3-2 below: 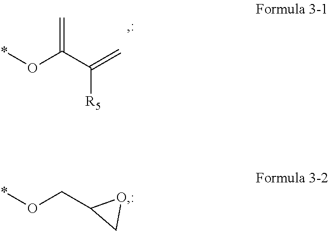
wherein in Formulas 3-1 and 3-2,
R₅ is a hydrogen atom or a substituted or unsubstituted methyl group, and [symbol]
is a site connected to Si of Formula 2.

7. The window of claim 1, wherein the high refractive layer has a refractive index that is greater than about 1.55 and less than about 1.65, and
the low refractive layer has a refractive index that is greater than about 1.40 and less than about 1.45.

8. The window of claim 1, wherein the inorganic particles comprise at least one of niobium oxide or zirconium oxide.

9. The window of claim 1, wherein the high refractive layer comprises the inorganic particles in an amount that is greater than about 5 wt % and less than about 25 wt % with respect to a total amount of the high refractive layer.

10. The window of claim 1, wherein the base resin comprises a (meth)acrylate-based resin.

11. The window of claim 1, wherein the base resin comprises a polymer derived from a resin composition that includes at least one of 3-functional (meth)acrylate, 6-functional (meth)acrylate, or 9-functional (meth)acrylate.

12. The window of claim 1, wherein the low refractive layer comprises no inorganic particles.

13. The window of claim 1, further comprising a functional layer disposed on the low refractive layer, wherein the functional layer includes a fluorine-containing compound.

14. A display device, comprising:
a display panel; and
a window disposed on the display panel,
wherein the window includes:
a base layer disposed on the display panel,
a high refractive layer disposed on the base layer, wherein the high refractive layer includes inorganic particles and a base resin; and
a low refractive layer disposed on the high refractive layer, wherein the low refractive layer includes a fluorine-containing silsesquioxane-based resin.

15. The display device of claim 14, wherein the fluorine-containing silsesquioxane-based resin is a silsesquioxane-based resin that includes at least one perfluoroalkyl group.

16. The display device of claim 14, wherein the fluorine-containing silsesquioxane-based resin comprises at least one of a (meth)acrylate group or an epoxy group.

17. The display device of claim 14, wherein the fluorine-containing silsesquioxane-based resin comprises a repeating unit represented by Formula 1 below: 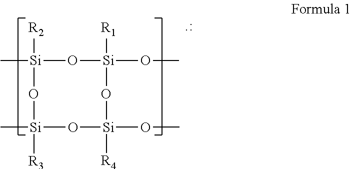
wherein in Formula 1,
R₁ to R₄ are each independently one of a hydrogen atom, a deuterium atom, a halogen atom, a substituted or unsubstituted alkyl group, a substituted or unsubstituted (meth)acrylate group, a substituted or unsubstituted aryl group that has 6 to 30 carbon atoms, an alkoxy group that has 1 to 10 carbon atoms substituted with an epoxy group, or a substituted or unsubstituted heteroaryl group that has 2 to 30 carbon atoms, and
at least one of R₁ to R₄ is a substituted or unsubstituted fluoroalkyl group, or a substituted or unsubstituted perfluoroalkyl group, and at least another one of R₁ to R₄ is a substituted or unsubstituted (meth)acrylate group, or an alkoxy group that has 1 to 10 carbon atoms substituted with an epoxy group.

18. The display device of claim 14, wherein the fluorine-containing silsesquioxane-based resin comprises a repeating unit represented by Formula 2 below: 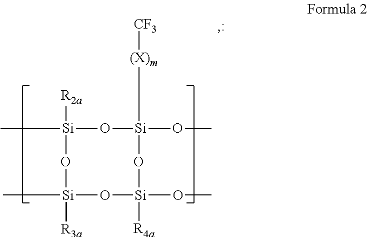
wherein in Formula 2,
X is —CF₂—,
m is an integer that is greater than or equal to 1 and less than or equal to 11, and
R₂ₐ to R₄ₐ are each independently one of a substituted or unsubstituted fluoroalkyl group, a substituted or unsubstituted perfluoroalkyl group, a substituted or unsubstituted (meth)acrylate group, or an alkoxy group that has 1 to 10 carbon atoms substituted with an epoxy group, and
at least one of R₂ₐ to R₄ₐ is a substituted or unsubstituted (meth)acrylate group, or an alkoxy group that has 1 to 10 carbon atoms substituted with an epoxy group.

19. The display device of claim 14, wherein the high refractive layer has a refractive index that is greater than about 1.55 and less than about 1.65, and
the low refractive layer has a refractive index that is greater than about 1.40 and less than about 1.45.

20. The display device of claim 14, wherein the display device comprises at least one foldable region that is configured to be folded with respect to a folding axis that extends in one direction.
